(19) United States
(12) Patent Application Publication
(10) Pub. No.: US 2023/0182399 A1
(43) Pub. Date: Jun. 15, 2023

(54) METHODS AND SYSTEMS FOR THREE-DIMENSIONAL PRINTING MANAGEMENT

(71) Applicant: HOLO, INC., Newark, CA (US)

(72) Inventors: Richard M. GREENE, San Rafael, CA (US); Daniel CHRISTIANSEN, San Francisco, CA (US); Patrick HENDRY, San Jose, CA (US)

(21) Appl. No.: 18/084,154

(22) Filed: Dec. 19, 2022

Related U.S. Application Data
(63) Continuation of application No. PCT/US21/38633, filed on Jun. 23, 2021.
(60) Provisional application No. 63/044,076, filed on Jun. 25, 2020.

(51) Int. Cl. B29C 64/393

(52) U.S. Cl. CPC B29C 64/393; B33Y 50/02

(57) ABSTRACT

The present disclosure provides a computer-implemented method for generating an application executable by a three-dimensional (3D) printing system to print a 3D object. The method may comprise providing at least one electronic file comprising a plurality of operations of the 3D printing system. An operation of the plurality of operations may be associated with a configuration of at least one component of the 3D printing system. The at least one electronic file may not comprise a source code usable to generate the application. The method may comprise using the at least one electronic file to generate at least another electronic file comprising the source code that is usable to generate the application.

### CROSS-REFERENCE

This application is a continuation of International Patent Application No. PCT/US21/38633, filed Jun. 23, 2021, which claims the benefit of U.S. patent application Ser. No. 63/044,076, filed Jun. 25, 2020, each of which is entirely incorporated herein by reference.

### BACKGROUND

Additive manufacturing techniques, such as three-dimensional (3D) printing, are rapidly being adopted as useful techniques for a number of different applications, including rapid prototyping and fabrication of specialty components. Examples of 3D printing include powder-based printing, fused deposition modeling (FDM), and stereolithography (SLA). In SLA printing technology, a 3D structure may be built by forming one layer at a time, where a subsequent layer adheres to the previous layer.

A 3D printing system may comprise a plurality of components, e.g., a build head to hold a 3D printed object or a portion thereof and/or a resin coater. A 3D printing process may involve controlling configurations (e.g., position, lateral and/or rotational movement, speed of movement, etc.) of one or more of the plurality of components. In an example, one or more actuators may be operatively linked to a component of the 3D printing system to direct movement of such component. In some cases, controlling discrete steps of the 3D printing process and configurations of the 3D printing system may be computer-implemented, e.g., executed by a computer processor.

### SUMMARY

The present disclosure provides methods and systems for three-dimensional (3D) printing. Methods and systems of the present disclosure may be used to generate an application executable by the 3D printing system to print at least a portion of a 3D object.

In an aspect, the present disclosure provides a computer-implemented method for generating an application executable by a three-dimensional (3D) printing system to print a 3D object, comprising: (a) providing at least one electronic file comprising a plurality of operations of the 3D printing system, wherein an operation of the plurality of operations is associated with a configuration of at least one component of the 3D printing system, and wherein the at least one electronic file does not comprise a source code usable to generate the application; and (b) using the at least one electronic file to generate at least another electronic file comprising the source code that is usable to generate the application.

In some embodiments, the at least one component comprises (i) at least one actuator configured to control movement of at least one part of the 3D printing system or (ii) at least one sensor configured to detect movement or condition of the at least one part of the 3D printing system. In some embodiments, the at least one component comprises (i) the at least one actuator and (ii) the at least one sensor. In some embodiments, the at least one part comprises one or more members selected from the group consisting of: a build head, a platform, a deposition head, a wiper, a film transfer unit, a coupling unit, an optical source, a camera, and a mixture usable for printing the 3D object.

In some embodiments of any of the methods herein, the at least one electronic file comprises (i) a first electronic file comprising the plurality of operations of the 3D printing system and (ii) a second electronic file comprising the configuration of the at least one component of the 3D printing system associated with each operation of the plurality of operations. In some embodiments, the second electric file comprises a plurality of electronic files for a plurality of components of the at least one component of the 3D printing system associated with each operation of the plurality of operations.

In some embodiments of any of the methods herein, the method further comprises, in (a), using an initial electronic file to generate the at least one electronic file, wherein the initial electronic file comprises (i) a first table comprising the plurality of operations of the 3D printing system and (ii) a second table comprising the configuration of the at least one component of the 3D printing system associated with each operation of the plurality of operations. In some embodiments, the second table comprises a plurality of tables for a plurality of components of the 3D printing system associated with each operation of the plurality of operations. In some embodiments, the generating the at least one electronic file is performed automatically by the computer.

In some embodiments of any of the methods herein, in (b), the generating the at least another electronic file is performed automatically by the computer.

In some embodiments of any of the methods herein, the plurality of operations are grouped into different processes of the 3D printing system in the at least one electronic file.

In some embodiments of any of the methods herein, the application comprises an instruction for the 3D printing system to automatically transition from a first operation to a second operation of the plurality of operations.

In some embodiments of any of the methods herein, the method further comprises using the at least another electronic file to generate the application executable by the 3D printing system.

In some embodiments of any of the methods herein, the 3D printing system comprises a state machine controller configured to execute the application to print the 3D object.

In another aspect, the present disclosure provides a system for generating an application executable by a three-dimensional (3D) printing system to print a 3D object, comprising: a computer storage unit configured to store at least one electronic file comprising a plurality of operations of the 3D printing system, wherein an operation of the plurality of operations is associated with a configuration of at least one component of the 3D printing system, and wherein the at least one electronic file does not comprise a source code usable to generate the application; and one or more computer processors operatively coupled to the computer storage unit, wherein the one or more computer processors are individually or collectively programmed to (i) retrieve the at least one electronic file from the computer storage unit, and (ii) use the at least one electronic file to generate at least another electronic file comprising the source code that is usable to generate the application. In some embodiments, the one or more computer processors are individually or collectively programmed to execute any of the methods herein.

In some embodiments, the at least one component comprises (i) at least one actuator configured to control movement of at least one part of the 3D printing system or (ii) at least one sensor configured to detect movement or condition of the at least one part of the 3D printing system.

In some embodiments of any of the systems herein, the at least one electronic file comprises (i) a first electronic file comprising the plurality of operations of the 3D printing system and (ii) a second electronic file comprising the configuration of the at least one component of the 3D printing system associated with each operation of the plurality of operations.

In some embodiments of any of the systems herein, the application comprises an instruction for the 3D printing system to automatically transition from a first operation to a second operation of the plurality of operations.

In some embodiments of any of the systems herein, the system further comprises a state machine controller configured to execute the application to print the 3D object.

In a different aspect, the present disclosure provides a computer-readable medium comprising non-transitory, machine-executable instructions that, upon execution by one or more computer processors, implements a method for generating an application executable by a three-dimensional (3D) printing system to print a 3D object, the method comprising: (a) providing at least one electronic file comprising a plurality of operations of the 3D printing system, wherein an operation of the plurality of operations is associated with a configuration of at least one component of the 3D printing system, and wherein the at least one electronic file does not comprise a source code usable to generate the application; and (b) using the at least one electronic file to generate at least another electronic file comprising the source code that is usable to generate the application. In some embodiments, the non-transitory, machine-executable instructions implement any of the methods herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIGS. 1A-1C schematically illustrate a diagram of a state machine for a three-dimensional (3D) printing system;

FIG. 2 illustrates an example flowchart of a computer-implemented method for generating an application executable by a 3D printing system;

FIG. 3 illustrates another example flowchart of a computer-implemented method for generating an application executable by a 3D printing system;

FIG. 4A shows an example table comprising a plurality of operations of a 3D printing system;

FIG. 4B shows an example table comprising a configuration of a plurality of actuators for each operation of a plurality of operations of a 3D printing system;

FIG. 4C shows an example table comprising a configuration of a plurality of sensors for each operation of a plurality of operations of a 3D printing system;

FIG. 5 shows examples of an electronic file comprising a source code usable to generate an application that is executable for a 3D printing system;

FIG. 6 shows an example of a 3D printing system;

FIGS. 7 and 8 show additional examples of a 3D printing system; and

FIG. 9 shows a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “state machine,” as used herein, generally refers to a logic function comprising a plurality of states (or operations) in a predetermined order. The logic function may use an input condition (e.g., an input from a user of the hardware) to determine the next state of the hardware and/or a logic output.

The terms “macro,” “macro-instruction,” and “macro-operation,” as used herein, generally refer to a series of actions that are recorded into a format (e.g., by a computer software, such as Microsoft® Office Excel) that can be re-executed at a later time to repeat the series of actions again.

The term “source code,” as used herein, generally refers to one or more commands that can be compiled or assembled into an executable computer program.

The term “unit,” as used herein, generally refers to a unit operation. A unit may include one or more components. For example, a computer storage unit may include one or more electronic components (e.g., computer memory) that are configured to store electronic data and/or an electronic file. A computer storage unit can be a database. Such database can include one or more physical storage media.

The term “real-time” or “real time,” as used interchangeably herein, generally refers to an event (e.g., an operation of a 3D printing process, a computation, a calculation, an analysis, movement of the at least one part of a 3D printing system, etc.) of the 3D printing systems and methods disclosed herein. A real-time event may be performed almost immediately or within a short enough time span, such as within at least 0.0001 millisecond (ms), 0.0005 ms, 0.001 ms, 0.005 ms, 0.01 ms, 0.05 ms, 0.1 ms, 0.5 ms, 1 ms, 5 ms, 0.01 seconds, 0.05 seconds, 0.1 seconds, 0.5 seconds, 1 second, or more. A real-time event may be performed almost immediately or within a short enough time span, such as within at most 1 second, 0.5 seconds, 0.1 seconds, 0.05 seconds, 0.01 seconds, 5 ms, 1 ms, 0.5 ms, 0.1 ms, 0.05 ms, 0.01 ms, 0.005 ms, 0.001 ms, 0.0005 ms, 0.0001 ms, or less.

Overview

Operations of a hardware, e.g., a three-dimensional (3D) printing system, may be regulated by an executable computer program (i.e., an application). In some cases, a state machine may be used by the executable computer program to control the flow of the hardware's operations.

The executable computer program may be generated based on an electronic file comprising (i) a plurality of operations of a hardware to be controlled by the application and (ii) a text listing of commands (i.e. a source code) to be compiled or assembled into the executable computer program. A scale and complexity of the state machine may increase, for example, in proportion to a number of operations of a hardware (e.g., a number of components of the hardware to control) and/or a number of input conditions. As such, a software engineer may be required to generate the electronic file comprising the source code, and a hardware engineer may be required to rely on the software engineer for modifying the executable computer program to accommodate for any update or modification in the hardware.

In view of the foregoing, there exists a need for alternative methods and systems for a user to generate an application executable by a hardware, e.g., a 3D printing system to print a 3D object, with minimal or no knowledge (or experience) in software engineering and/or source code languages. Additionally, there exists a need for alternative methods and systems for a user to generate an application executable by a hardware in more rapidly.

Methods and Systems for 3D Printing Management

Methods and systems for hardware management, as provided herein, can allow a user to generate an application executable by a hardware for its operation, e.g., a 3D printing system for printing a 3D object, based on one or more electronic documents that do not comprise any source code. The application may comprise a state machine, and the methods and systems may allow a non-software engineer (e.g., a mechanical engineer, a user, etc.) to (i) review and understand a plurality of states (or operations) of the state machine and/or (ii) modify at least a portion of the state machine (e.g., change an order of two or more states), e.g., via use of a spreadsheet that does not comprise any source code. In some cases, the at least the portion of the state machine may be modified based on modification of the hardware of operations thereof. For example, one or more states of the plurality of states provided in one or more electronic files (e.g., one or more spreadsheets that do not comprise a source code) may be modified without using, modifying, and/or needing any source code. In another example, one or more states of the plurality of states provided in the one or more electronic files may be partitioned into different subsets without using, modifying, and/or needing any source code. By reducing or eliminating the need to utilize source codes for one or more operations of the methods and systems for 3D printing as disclosed herein, a user may gain more freedom to control or modify (e.g., personalize) such one or more operations without relying on manufacturer or engineer of the system.

The methods and systems for hardware management may allow a user to generate or update a spreadsheet (e.g., by a computer software, such as Microsoft® Office Excel) that defines the plurality of states and does not comprise any source code, and use a macro to convert (e.g., automatically convert) the spreadsheet into the application executable by the hardware. For 3D printing, the methods and systems disclosed herein may design a state machine based on (i) a flow of a plurality of states of the state machine and (ii) condition of one or more components (e.g., actuators, sensors, etc.) of the 3D printing system or a product thereof (e.g., a printed layer of a 3D object).

In an aspect, the present disclosure provides a computer-implemented method for generating an application executable by a system to operate. The computer-implemented method (i.e., the method) may comprise providing at least one electronic file comprising a plurality of operations of the system. An operation of the plurality of operations may be associated with a configuration of at least one component of the system. The at least one electronic file may not comprise a source code usable to generate the application. The method may comprise using the at least one electronic file to generate at least another electronic file comprising the source code that is usable to generate the application. The method may further comprise using the at least another electronic file to generate the application executable by the system. In some cases, the system may be a 3D printing system to print a 3D object.

A file format of the at least one electronic file may be .XLS, .XLSX, .DOC, .DOCX, .PPT, .PPTX, .TXT, .CSV, .RTF, .WKS, .WK1, and/or .WK2. In an example, the at least one electronic file may be provided as a .csv file.

The at least one component of the 3D printing system may comprise at least one actuator configured to control movement of at least one part of the 3D printing system. The at least one actuator may control a relative movement of the at least one part within the 3D printing system. For example, the at least one actuator may control a relative movement of a first part of the 3D printing system with respect to one or more additional parts of the 3D printing system. In an example, the at least one actuator may control a relative movement of a deposition head with respect to a platform and/or a film transfer unit of the 3D printing system. The at least one actuator may be operatively coupled to the at least one part. The at least one actuator may be directly coupled to the at least one part. Alternatively, the at least one actuator may be indirectly coupled to the at least one part. For example, the at least one actuator may be coupled to a support structure, and the support structure may be coupled to the at least one part.

The at least one actuator may be operatively coupled (e.g., via wired or wireless communications) to a controller of the 3D printing system. The controller may direct operation of the actuator in real-time, in near real-time, and/or or at a later time point upon generation of the sensor data.

The at least one actuator may be capable of directing movement of the at least one part of the 3D printing system in at least one degree of freedom. The at least one actuator may be capable of directing movement of the at least one part in at least 1, 2, 3, 4, 5, 6, or more degrees of freedom (e.g., up, down, right, left, forward, backwards, roll, pitch, and/or yaw). The at least one actuator may be capable of directing movement of the at least one part in at most 6, 5, 4, 3, 2, or 1 degree of freedom. In some cases, the at least one actuator may be capable of directing movement of the 3D printing system.

The at least one actuator may be one or more of a stepper actuator, linear actuator, hydraulic actuator, pneumatic actuator, electric actuator, magnetic actuator, and mechanical actuator (e.g., rack and pinion, chains, etc.). For example, the at least one actuator may be a servomotor, brushed electric motor, brushless electric motor (e.g., stepper motor), torque motor, or shaft actuator (e.g. hollow shaft actuator).

The 3D printing system may comprise at least 1, 2, 3, 4, 5, 6, 7, 8, 9, 10, 11, 12, 13, 14, 15, 16, 17, 18, 19, 20, 21, 22, 23, 24, 25, 30, 35, 40, 45, 50, or more actuators. The 3D printing system may comprise at most 50, 45, 40, 35, 30, 25, 24, 23, 22, 21, 20, 19, 18, 17, 16, 15, 14, 13, 12, 11, 10, 9, 8, 7, 6, 5, 4, 3, 2, or 1 actuator. The at least one part of the 3D printing system may be operatively coupled to at least 1, 2, 3, 4, 5, 6, 7, 8, 9, 10, or more actuators. The at least one part of the 3D printing system may be operatively coupled to at most 10, 9, 8, 7, 6, 5, 4, 3, 2, or 1 actuator. An individual actuator may be operatively coupled to at least 2, 3, 4, 5, 6, 7, 8, 9, 10, or more different parts of the 3D printing system. The individual actuator may be operatively coupled to at most 10, 9, 8, 7, 6, 5, 4, 3, or 2 different parts of the 3D printing system. In some cases, an individual actuator may be operatively coupled to a single part of the 3D printing system.

The at least one component of the 3D printing system may comprise at least one sensor configured to detect movement (e.g., up, down, right, left, forward, backwards, roll, pitch, and/or yaw) and/or condition of the at least one part of the 3D printing system. Examples of the condition of the at least one part can include, but are not limited to, (i) a relative position within the 3D printing system, (ii) a relative position with respect to one or more different parts of the 3D printing system (e.g., a coupling (or de-coupling) of the at least one part to one or more different parts, (iii) a presence and/or thickness of a material (e.g., a mixture comprising a resin) deposited adjacent to the at least one part (e.g., a platform, window, or film), (iv) a presence, shape, and/or thickness of a material (e.g., a printed layer of the 3D object) disposed adjacent to the at least one part (e.g., a build head), (v) a direction, speed, and, or acceleration of movement of the at least one part relative to the 3D printing system, etc.

The at least one sensor may be operatively coupled (e.g., via wired or wireless communications) to a controller of the 3D printing system. The controller may direct operation of the at least one sensor. The controller may receive sensor data from the at least one sensor. The controller may receive the sensor data that is generated by the at least one sensor in real-time, in near real-time, and/or at a later time point upon generation of the sensor data.

The at least one sensor may be operatively coupled to the at least one part. The at least one sensor may be directly coupled to the at least one part. Alternatively or in addition to, the at least one sensor may not be directly coupled to the at least one part. The at least one sensor may be indirectly coupled to the at least one part, such that the movement and/or condition of the at least one part can be detected by the at least one sensor.

The at least one sensor may comprise a contact sensor and/or a non-contact sensor. The at least one sensor may comprise at least one pressure sensor (e.g., at least 1, 2, 3, 4, 5, or more pressure sensors) configured to detect a pressure between a first part and a second part of the 3D printing system. The at least one sensor may comprise at least one electrical current sensor (e.g., at least 1, 2, 3, 4, 5, or more electrical current sensors) configured to detect an electrical current between the first part and the second part. In an example, a non-contact sensor may comprise a magnetic field sensor configured to detect a magnetic field between the first part and the second part. In another example, the non-contact sensor may comprise at least one camera (e.g., at least 1, 2, 3, 4, 5, or more cameras) configured to capture one or more images or videos of the at least one part. In another example, the contact sensor may comprise at least one piezoelectric sensor (e.g., at least 1, 2, 3, 4, 5, or more piezoelectric sensors). In another example, the contact sensor may comprise at least one force sensor (e.g., at least 1, 2, 3, 4, 5, or more force sensors). In a different example, the contact sensor may comprise at least one contact switch (e.g., at least 1, 2, 3, 4, 5, or more contact switches).

The at least one sensor may comprise a motion sensor capable of sensing position, orientation, and/or accelerations of the at least one part of the 3D printing system. The motion sensor may be an inertial measurement unit (IMU). Examples of the motion sensor can include, but are not limited to, an accelerometer (e.g., a three-axes accelerometer), a gyroscope (e.g., a three-axes gyroscope), and/or a magnetometer (e.g., a three-axes magnetometer).

The at least one sensor may be operatively coupled to the at least one part. The at least one sensor may be directly coupled to the at least one part. Alternatively or in addition to, the at least one sensor may not be directly coupled to the at least one part. The at least one sensor may be indirectly coupled to the at least one part, such that the movement and/or condition of the at least one part can be detected by the at least one sensor.

The 3D printing system may comprise at least 1, 2, 3, 4, 5, 6, 7, 8, 9, 10, 11, 12, 13, 14, 15, 16, 17, 18, 19, 20, 21, 22, 23, 24, 25, 30, 35, 40, 45, 50, or more sensors. The 3D printing system may comprise at most, 50, 45, 40, 35, 30, 25, 24, 23, 22, 21, 20, 19, 18, 17, 16, 15, 14, 13, 12, 11, 10, 9, 8, 7, 6, 5, 4, 3, 2, or 1 sensor. The at least one part of the 3D printing system may be operatively coupled to at least 1, 2, 3, 4, 5, 6, 7, 8, 9, 10, or more sensors. The at least one part of the 3D printing system may be operatively coupled to at most 10, 9, 8, 7, 6, 5, 4, 3, 2, or 1 sensor. An individual sensor may be operatively coupled to at least 2, 3, 4, 5, 6, 7, 8, 9, 10, or more different parts of the 3D printing system. The individual sensor may be operatively coupled to at most 10, 9, 8, 7, 6, 5, 4, 3, or 2 different parts of the 3D printing system. In some cases, an individual sensor may be operatively coupled to a single part of the 3D printing system.

In some cases, the at least one component of the 3D printing system may comprise both the at least one actuator and the at least one sensor.

The at least one part of the 3D printing system can include, but are not limited to, at least one build head (e.g., at least 1, 2, 3, 4, 5, or more build heads), at least one platform (e.g., at least 1, 2, 3, 4, 5, or more platforms), at least one deposition head (e.g., at least 1, 2, 3, 4, 5, or more deposition heads), at least one wiper (e.g., at least 1, 2, 3, 4, 5, or more wipers), at least one film transfer unit (e.g., at least 1, 2, 3, 4, 5, or more film transfer units), at least one coupling unit (e.g., at least 1, 2, 3, 4, 5, or more coupling units), at least one optical source (e.g., at least 1, 2, 3, 4, 5, or more optical sources), at least one camera (e.g., at least 1, 2, 3, 4, 5, or more cameras), at least one mixture usable for printing the 3D object (e.g., at least 1, 2, 3, 4, 5, or more mixtures that are different or the same), at least one container configured to hold the mixture (e.g., at least 1, 2, 3, 4, 5, or more mixtures), and/or at least one transfer device (e.g., at least 1, 2, 3, 4, 5, or more transfer devices).

The at least one wiper may be a blade (e.g., a doctor blade), a roller, and/or a rod. The at least one optical source may be capable of emitting at least 1, 2, 3, 4, 5, or more different wavelengths, such as a photoinitiation light and a photoinhibition light that are different. The at least one transfer device may be a mixture transfer device (e.g., a fluidic device, a nozzle, etc.) configured to transfer the mixture from one part of the 3D printing system to another (e.g., from the container to the window or film, and/or vice versa). Alternatively or in addition to, the at least one transfer device may be a transport unit configured to transport a printed 3D object (or a portion thereof) from the 3D printing system to a processing unit (e.g., a debinding unit, a sintering unit, etc.). The transport unit can comprise a roller, a belt, a chain, a chute, and/or a pulley.

In some cases, the 3D printing system may be a collection of a plurality of 3D printing systems and/or a collection of at least one 3D printing system and a processing unit. Such collection may be operatively coupled to each other by the at least one transfer device. Examples of the processing unit can include, but are not limited to, a 3D object cleaning unit, debinding unit capable of debinding at least a portion of a polymer within a printed 3D object, and a sintering unit. The debinding unit may utilize a liquid (e.g., a solvent) and/or thermal energy for the debinding. The sintering unit may utilize thermal energy for the sintering. The heat for debinding and/or sintering may be supplied by an optical source.

Examples of an optical source, as provided herein, may include lamps, torches, lasers, light emitting diodes (LEDs), super luminescent diodes (SLDs), gas-filled tubes such as fluorescent bulbs, or any other equipment capable of producing a stream of photons. An optical source may emit electromagnetic waves with one or more wavelengths ranging from about 200 nm to about 700 nm. The optical source may emit electromagnetic waves with one or more wavelengths less than about 200 nm. The optical source may emit electromagnetic waves with one or more wavelengths greater than about 700 nm. In an example, an optical source may include sources of ultraviolet (UV) light. Other examples of a source of thermal energy may include lamps, torches, lasers, heaters, furnaces, or an open flame.

In some cases, the optical source used for printing at least a portion of a 3D object can include a first wavelength for photoinitiation and a second wavelength (different from the first wavelength) for photoinhibition. The optical source used for sintering may be located external to the green part.

The at least one electronic file may comprise at least 1, 2, 3, 4, 5, 6, 7, 8, 9, 10, or more electronic files that may not comprise a source code usable to generate the application. The at least one electronic file may comprise at most 10, 9, 8, 7, 6, 5, 4, 3, 2, or 1 electronic file. The at least one electronic file may comprise a single electronic file. Alternatively, the at least one electronic file may comprise a plurality of electronic files. The plurality of electronic files may be the same or different. In some cases, the at least one electronic file may comprise a first electronic file and at least a second electronic file (e.g., at least a second electronic file, a third electronic file, a fourth electronic file, a fifth electronic file, or more; at most a fifth electronic file, a fourth electronic file, a third electronic file, or a second electronic file). The first electronic file may comprise descriptions (e.g., in texts and/or diagrams) of the plurality of operations of the 3D printing system. The at least the second electronic file may comprise descriptions (e.g., in texts and/or diagrams) of the configuration of the at least one component of the 3D printing system associated with each operation of the plurality of operations. Such descriptions within the at least one electronic file may be provided in a non-source code form, such that a non-software engineer (e.g., a hardware engineer) may be able to create or modify the executable computer program for the 3D printing system.

In some examples, the second electronic file may comprise a configuration of the at least one actuator that is associated with each operation of the plurality of operations of the 3D printing system, and the third electronic file may comprise a configuration of the at least one sensor that is associated with each operation of the plurality of operations of the 3D printing system.

In the at least one electronic file, the configuration of the at least one component of the 3D printing system may be provided in one or more text codes (e.g., numbers, alphabets, and/or symbols). Alphabets may comprise one or more letters from Afrikaans, Albanian, Amharic, Arabic, Armenian, Assamese, Assyrian, Avar, Azerbaijani, Balinese, Bamara Bantu, Bashkir, Basque, Bengali Birhari, Bulgarian, Buluba-Lulua, Burmese, Buryat, Byelorussian, Caddoan, Cantonese, Catalan, Chechen, Chikaranga, Chippewa, Choctaw, Church Slavik, Chuvash, Coptic, Cree, Croatian, Cyrillic, Czech, Dakota, Danish, Dari, Devanagari, Dutch, Dzongkha, English, Eskimo, Esperanto, Estonian, Ewe, Farsi, Fijian, Filipino, Finnish, Flemish, French, Fulani, Gaelic, Galician, Gcorgian, German, Greek, Gujarati, Gurmakhi, Harari, Hausa, Hawaiian, Hebrew, Hindi, Hiragana, Ibo, Icelandic, Indonesian, Irish, Irogquoian, Italian, Japanese, Kabardian, Kalmyk, Kannada, Kanuri, Kashmiri, Katakana, Kazakh, Khasi, Khmer, Kirghiz, Kishmiri, Komi, Kongo, Korean, Kurdish, Lao, Latin, Latvian, Lithuanian, Lu-Guanda, Macedonian, Magahi Maithili, Makua, Malagasy, Malay, Malayalam, Maltese, Mandarin, Mandingo, Manipuri, Marathi, Masai, Mizo, Moldavian, Mongolian, Munda, Naga, Navaho, Nyanja, Nepalese, Norwegian, Oriya, Oromo, Ossetian, Pashto, Polish, Portugese, Punjabi, Rajasthani, Rhaeto-Romanic, Rumanian, Russian, Samoan, Sangs, Serbian, SerboCroatian, Sinhalese, Sinhi, Sioux, Slovak, Slovenia, Spanish, Sundanese, Swahili, Swedish, Syriac, Tadzhik, Tagalog, Tajik, Tamil, Tatar, Telugu, Thai, Tibetan, Turkish, Turknen, Udmurt, Uighur, Ukrainian, Umbundu, Urdu, Uzbek, Vietnamese, Visayan, Welsh, Yakut, Yoruba, or a combination thereof.

The method may further comprise using at least one initial electronic file to generate the at least one electronic file. The at least one initial electronic file may comprise (i) a first chart comprising the plurality of operations of the 3D printing system and (ii) at least a second chart (e.g., at least a second chart, a third chart, a fourth chart, a fifth chart, or more; at most a fifth chart, a fourth chart, a third chart, or a second chart). The at least the second chart may comprise the configuration of the at least one component of the 3D printing system associated with each operation of the plurality of operations. Examples of the chart may include, but are not limited to, at least one table (e.g., at least 1, 2, 3, 4, 5, or more tables), a graph (e.g., at least 1, 2, 3, 4, 5, or more graphs), and/or a diagram (e.g., at least 1, 2, 3, 4, 5, or more diagrams). In some cases, the chart may comprise a grid (e.g., a plurality of rows and a plurality of columns), such as a spreadsheet. In some cases, the at least one initial electronic file may be generated by using one or more spreadsheet programs (e.g., Microsoft® Office Excel, Microsoft® Office Word, Microsoft® Office PowerPoint, Lotus 1-2-3, etc.). A file format of the at least one initial electronic file may be .XLS, .XLSX, .DOC, .DOCX, .PPT, .PPTX, .TXT, .CSV, .RTF, .WKS, .WK1, and/or .WK2. The at least one initial electronic file may not comprise the source code that is usable to generate the application.

In an example, the second chart (e.g., a second table) may comprise a configuration of the at least one actuator that is associated with each operation of the plurality of operations of the 3D printing system, and the third chart (e.g., a third table) may comprise a configuration of the at least one sensor that is associated with each operation of the plurality of operations of the 3D printing system. In another example, the second chart (e.g., a second table) may comprise (i) a configuration of the at least one actuator that is associated with each operation of the plurality of operations of the 3D printing system, and (ii) a configuration of the at least one sensor that is associated with each operation of the plurality of operations of the 3D printing system. A plurality of charts of the at least one initial electronic file may be provided in a single initial electronic file. Alternatively, the plurality of charts of the at least one initial electronic file may be provided in a plurality of separate electronic files. The plurality of separate electronic files may be provided in the same or different file formats.

The at least another electronic file may comprise at least 1, 2, 3, 4, 5, or more another electronic files. The at least another electronic file may comprise at most 5, 4, 3, 2, or 1 another electronic file. The at least another electronic file may be a collection of a plurality of electronic files that are the same or different. The generating the at least one electronic file may be performed automatically by the computer, e.g., upon instruction from a user of the computer.

A programming language used by the programming language generator can comprise Array languages, Assembly languages, Authoring languages, Constraint programming languages, Command line interface languages, Compiled languages, Concurrent languages, Curly-bracket languages, Dataflow languages, Data-oriented languages, Decision table languages, Declarative languages, Embeddable languages, Educational languages, Esoteric languages, Extension languages, Extension, Fourth-generation languages, Functional languages, Hardware description languages, Imperative languages, Interactive mode languages, Interpreted languages, Iterative languages, Languages by memory management type, List-based languages, Little languages, Logic-based languages, Machine languages, Macro languages, Metaprogramming languages, Multiparadigm languages, Numerical analysis, Non-English-based languages, Object-oriented class-based languages, Object-oriented prototype-based languages, Off-side rule languages, Procedural languages, Query languages, Reflective language, Rule-based languages, Scripting languages, Stack-based languages, Synchronous languages Shading languages, Syntax handling languages, System languages, Transformation languages, Visual language, Wirth languages, and/or Extensible Markup Language (XML)-based languages.

Examples of the programming language can include, but are not limited to, A# .NET, A-0 System, A+, A++, ABAP, ABC, ABC ALGOL, ACC, Accent, Ace DASL (Distributed Application Specification Language), Action!, ActionScript, Actor, Ada, Adenine, Agda, Agilent VEE, Agora, AIMMS, Aldor. Alef, ALF, ALGOL 58, ALGOL 60, ALGOL 68, ALGOL W, Alice, Alma-0, AmbientTalk, Amiga E, AMOS, AMPL, AngelScript, Apex, APL, App Inventor for Android's visual block language, AppleScript, APT, Arc, ARexx, Argus, Assembly language, AutoHotkey, AutoLISP/Visual LISP, Averest, AWK, Axum, B, Babbage, Ballerina, Bash, BASIC, bc, BCPL, BeanShell, Batch file (Microsoft® Windows/MS-DOS), Bertrand, BETA, BLISS, Blockly, BlooP, Boo, Boomerang, Bosque, Bourne shell including bash and ksh), C, C−−(C minus minus), C++(C plus plus)-ISO/IEC 14882, C*, C# (C sharp)-ISO/IEC 23270, C/AL, Caché ObjectScript, C Shell (csh), Caml, Cayene, CDuce, Cecil, Cesil, Céu, Ceylong, CFEngine, Cg, Ch, Chapel, Charm, CHILL, CHIP-8, chomski, ChucK, Cilk, Citrine, CL (IBM), Claire, Clarion, Clean, Clipper, CLIPS, CLIST, Clojure, CLU, CMS-2, COBOL-ISO/IEC 1989, CobolScript-Cobol Scripting language, Cobra, CoffeeScript, ColdFusion, COMAL, Combined Programming Language (CPL), COMIT, Common Intermediate Language (CIL), Common Lisp (also known as CL), COMPASS, Component Pascal, Constraint Handling Rules (CHR), COMTRAN, Cool, Coq, Coral 66, CorVision, COWSEL, CPL, Cryptol, Crystal, Csound, Cuneiform, Curl, Curry, Cybil, Cyclone, Cypher Query Language, Cython, D, DASL (Datapoint's Advanced Systems Language), Dart, Darwin, DataFlex, Datalog, DATATRIEVE, dBase, dc, DCL, DinkC, DIBOL, Dog, Draco, DRAKON, Dylan, DYNAMO, DAX (Data Analysis Expressions), E, Ease, Easy PL/I, EASYTRIEVE PLUS, eC, ECMAScript, Edinburgh IMP, EGL, Eiffel, ELAN, Elixir, Elm, Emacs Lisp, Emerald, Epigram, EPL (Easy Programming Language), EPL (Eltron Programming Language), Erlang, es, Escher, ESPOL, Esterel, Etoys, Euclid, Euler, Euphoria, EusLisp Robot Programming Language, CMS EXEC (EXEC), EXEC 2, Executable UML, Ezhil, F, F#, F*, Factor, Fantam, FAUST, FFP, fish, Fjölnir, FL, Flavors, Flex, FlooP, FLOW-MATIC, FOCAL, FOCUS, FOIL, FORMAC, @Formula, Forth, Fortran-ISO/IEC 1539, Fortress, FP, Franz Lisp, Futhark, F-Script, Game Maker Language, GameMonkey Script, GAMS, GAP, G-code, GDScript, Genie, GDL, GEORGE, GLSL GNU E, Go, Go!, GOAL, Godel, Golo, GOM (Good Old Mad), Google Apps Script, Gosu, GOTRAN, GPSS, GraphTalk, GRASS, Grasshopper, Groovy, Hack, HAGGIS, HAL/S, Halide (programming language), Hamilton C shell, Harbour, Hartmann pipelines, Haskell, Haxe, Hermes, High Level Assembly, HLSL, Hollywood, HolyC, Hop, Hopscotch, Hope, Hugo, Hume, HyperTalk, lo, Icon, IBM Basic assembly language, IBM HAScript, IBM Informix-4GL, IBM RPG, IDL, Idris, Inform, J, J#, J++, JADE, JAL, Janus (concurrent constraint programming language), Janus (time-reversible computing programming language), JASS, Java, JavaFX Script, JavaScript, Jess (programming language), JCL, JEAN, Join Java, JOSS, Joule, JOVIAL, Joy, JScript, JScript.NET, Julia, Jython, K, Kaleidoscope, Karel, KEE, Kixtart, Klerer-May System, KIF, Kojo, Kotlin, KRC, KRL, KRL (KUKA Robot Language), KRPTON, Korn shell (ksh), Kodu, Kv, LabVIEW, Ladder, LANSA, Lasso, Lava, LC-3, Legoscript, LIL, LilyPond, Limbo, Limnor, LINC, Lingo, LINQ, LIS, LISA, Lisp-ISO/IEC 13816, Lite-C, Lithe, Little b, LLL, Logo, Logtalk, LotusScript, LPC, LSE, LSL, LiveCode, LiveScript, Lua, Lucid, Lustre, LYaPAS, Lynx, M2001, M4, M#, Machine Code, MAD (Michigan Algorithm Decoder), MAD/I, Magik, Magma, Maude system, Mani, Maple, MAPPER (now part of BIS), MARK-IV (now VISION:BUILDER), Mary, MASM Microsoft Assembly x86, MATH-MATIC, Mathematica, MATLAB, Maxima (see also Macsyma) Max (Max Msp-Graphical Programming Environment), MaxScript internal language 3D Studio Max, Maya (MEL), MDL, Mercury, Mesa, Metafont, MHEG-5 (Interactive TV programming language), Microcode, MicroScript, MIIS, Milk (programming language), MIMIC, Mirah, Miranda, MIVA Script, MIVA Script, ML, Model 204, Modelica, Modula, Modula-2, Modula-3, Mohol, MOO, Mortran, Mouse, MPD, Mathcad, MSL, MUMPS, MuPad, Mutan, Mystic Programming Language (MPL), NASM, Napier88, Neko, Nemerle, NESL, Net.Data, NetLogo, NetRexx, NewLISP, NEWP, Newspeak, NewtonScript, Nial, Nice, Nicle (NITIN), Nim, NPL, Not eXactly C (NXC), Not Quite C (NQC), NSIS, Nu, NWScript, NXT-G, o:XML, Oak, Oberon, OBJ2, Object Lisp, ObjectLOGO, Object REXX, Object Pascal, Objective-C, Objective-J, Obliq, OCaml, occam, occam-TT Octave, OmniMark, Opa, Opal, OpenCL, OpenEdge ABL, OPL, Open Vera, OPSS, OptimJ, Orc, ORCA/Modula-2, Oriel, Orwell Oxygene, Oz, P, P4, P″, ParaSail (programming language), PARI/GP, Pascal-ISO 7185, Pascal Script, PCASTL, PCF, PEARL, PeopleCode, Perl, PDL, Pharo, PHP, Pico, Picolisp, Pict, Pig (programming tool), Pike, PILOT, Pipelines, Pizza, PL-11, PL/0, PL/B, PL/C, PL/I-ISO 6160, PL/M, PL/P, PL/SQL, PL360, PLANC, Plankalkül, Planner, PLEX, PLEXIL, Plus, POP-11, POP-2, PostScript, PortablE, POV-Ray SDL, Powerhouse, PowerBuilder-4GL GUI application generator from Sybase, PowerShell, PPL, Processing, Processing.js, Prograph, PROIV, Prolog, PROMAL, Promela, PROSE modeling language, PROTEL, ProvideX, Pro*C, Pure, Pure Data, PureScript, Python, Q (programming language from Kx Systems), Q# (Microsoft programming language), Qalb, QtScript, QuakeC, QPL, Qbasic, .QL, R, R++, Racket, Raku, RAPID, Rapira, Ratfiv, Ratfor, rc, React, React Native, Reason, REBOL, Red, Redcode, REFAL, REXX, Rlab, ROOP, RPG, RPL, RSL, RTL/2, Ruby, Rust, S, S2, S3, S-Lang, S-PLUS, SA-C, SabreTalk, SAIL, SAM76, SAS, SASL, Sather, Sawzall, Scala, Scheme, Scilab, Scratch, Script.NET, Sed, Seed7, Self, SenseTalk, SequenceL, Serpent, SETL, SIMPOL, SIGNAL, SiMPLE, SIMSCRIPT, Simula, Simulink, Singularity, SISAL, SLIP SMALL, Smalltalk, SML, Strongtalk, Snap!, SNOBOL (SPITBOL), Snowball, SOL, Solidity, SOPHAEROS, Source, SPARK, Speakeasy, Speedcode, SPIN, SP/k, SPS, SQL, SQR, Squeak, Squirrel, SR, S/SL, Starlogo, Strand, Stata, Stateflow, Subtext, SBL, SuperCollider, SuperTalk, Swift (Apple programming language), Swift (parallel scripting language), SYMPL, SystemVerilog, T, TACL, TACPOL, TADS, TAL, Tcl, Tea, TECO, TELCOMP, TeX, TEX, TIE, TMG compiler-compiler, Tom, TOM, Toi, Topspeed, TPU, Trac, TTM, T-SQL, Transcript, TTCN, Turing, TUTOR, TXL, TypeScript, Tynker, Ubercode, UCSD Pascal, Umple, Unicon, Uniface, UNITY, Unix shell, UnrealScript, Vala, Verilog, VHDL, Vim script, Viper, Visual Basic, Visual Basic .NET, Visual C++, Visual DataFlex, Visual DialogScript, Visual Fortran, Visual FoxPro, Visual J++, Visual LISP, Visual Objects, Visual Prolog, VSXu, WATFIV, WATFOR, WebAssembly, WebDNA, Whiley, Winbatch, Wolfram Language, Wyvern, X++, X10, xBase, xBase++, XBL, XC (targets XMOS architecture), xHarbour, XL, Xojo, XOTcl, XOD (programming language), XPL, XPL0, XQuery, XSB, XSharp, XSLT, Xtend, Yorick, YQL, Yoix, YUI, Z notation, Zebra, ZPL, ZPL2, Zeno, ZetaLisp, ZOPL, Zsh, ZPL and/or Z++.

The plurality of operations may define each state of a state machine of the application executable by the 3D printing system to print the 3D object. The plurality of operations may be grouped into different processes (i.e., groups) of the 3D printing system, e.g., in the at least one electronic file, the at least another electronic file, the initial electronic file, etc. The application may be used by the 3D printing system to control a group transition between a first group and a second group (and/or vice versa). In some cases, the group transition may be triggered by an instruction from a user. In some cases, the application may comprise an instruction for the 3D printing system to automatically group transition, e.g., based on one or more feedback from the at least one actuator and/or the at least one sensor. Alternatively, the plurality of operations may not be grouped into different processes (i.e., groups) of the 3D printing system.

The application may comprise an instruction for the 3D printing system to automatically transition from a first operation to a second operation of the plurality of operations, e.g., based on one or more feedback from the at least one actuator and/or the at least one sensor. In an example, when a sensor data received from the at least one sensor is within an acceptable range (e.g., within a predetermined range), the instruction may direct the 3D printing system to automatically transition from the first operation to the second operation. When the sensor data is outside of the acceptable range, the instruction may (i) direct the at least one sensor to collect a new sensor data (e.g., for re-assessment) and/or (ii) direct the 3D printing system to stop the 3D printing process (e.g., until intervention by the user). Alternatively or in addition to, the transition from the first operation to the second operation of the plurality of operations may be triggered by an instruction from the user.

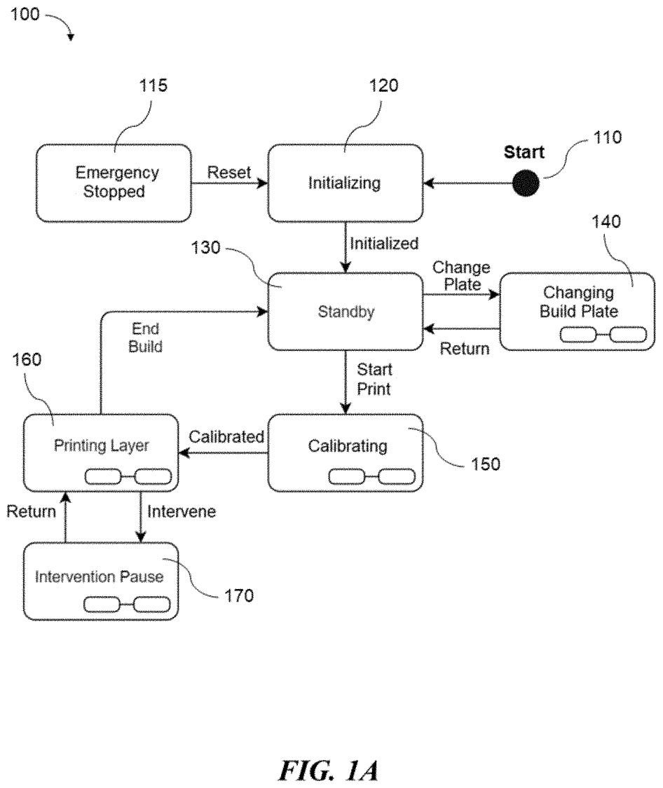

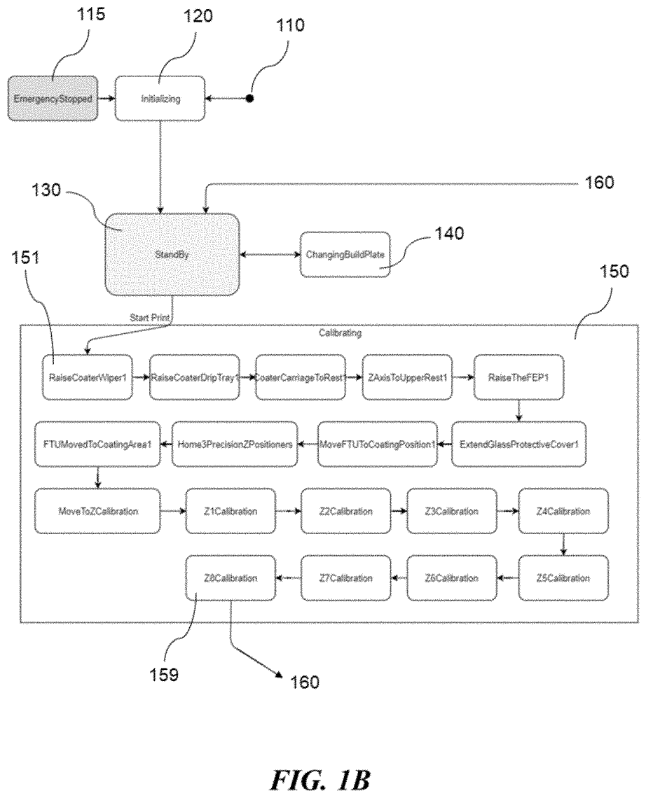

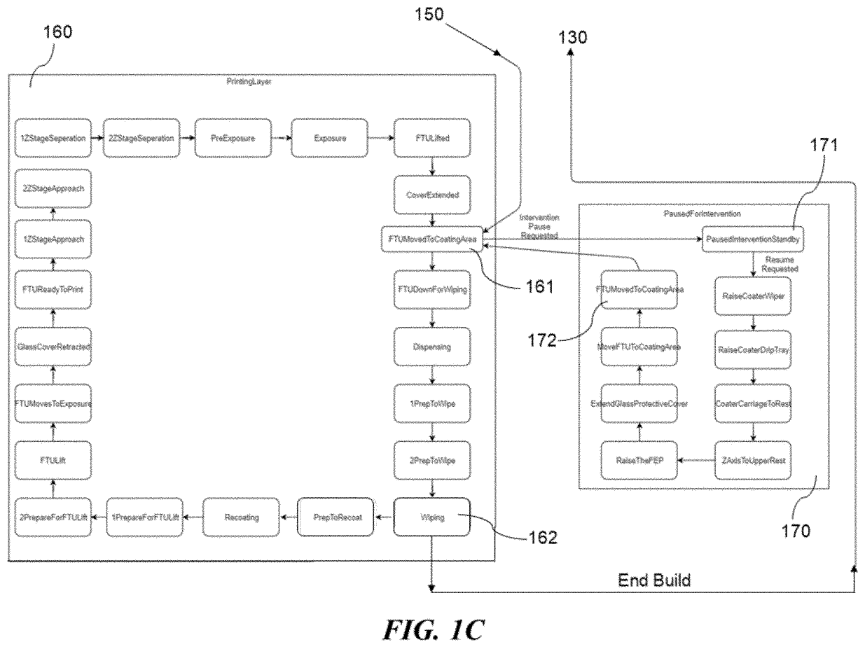

FIGS. 1A-1C schematically illustrates a diagram of a state machine 100 of the application executable by any of the 3D printing system disclosed herein. The 3D printing system may comprise a plurality of actuators. A state of the state machine may specify one or more commands for each of the plurality of actuators. The 3D printing system may comprise a plurality of sensors. A state of the state machine may specify a predetermined range of acceptable sensor data (e.g., sensor values). The state machine may be programmed to direct the 3D printing system from a first state to another state if the sensor data is within the predetermined range. The one or more commands (e.g., for the at least one actuator) can be executed on entry to and/or exit from any state of the state machine. The one or more commands can instruct the 3D printing system to pause within any state and/or between any states, then resume. The state machine can comprise one or more dedicated pauses (i.e., one or more intervention pauses) for a user of the 3D printing system to intervene. For example, the user may be able open a door to gain access to the printed 3D object or at least a portion thereof. In another example, the user may be able to gain access to a source of the mixture.

Referring to FIG. 1A, the state machine 100 may comprise an “entry point” state 110 to enter the state machine. The state machine 100 may comprise an “initializing” state 120 configured to initialize the at least one actuator and/or the at least one sensor of the 3D printing system. Thus, the “initializing state” 120 may be configured to initialize one or more parts of the 3D printing system (e.g., a deposition head, a build head, a wiper, an optical source, etc.). The state machine 100 may comprise a “standby state” 130 operatively connected to the “initializing state” 120. Once one or more initialization processes (e.g., all of the initialization processes) of the “initializing state” 120 are completed, the state machine may transition from the “initializing state” 120 to the “standby” state 130. The “standby” state 130 may be operatively connected to a “changing build plate” state 140. The “changing build plate” state 140 may be a single state or group of a plurality of states. The 3D printing system may comprise a plurality of build plates, wherein a build plat is configured to hold at least a portion of a 3D object. In the “changing build plate” state 140, the 3D printing system may be instructed by the state machine to switch from one build plat to another. Alternatively or in addition to, in the “changing build plate” state 140, the user may be able to change the build plate manually. Once the build plate is changed, the “changing build plate” state 140 may be programmed to return (e.g., automatically return) to the “standby” state 130.

Referring to FIG. 1A, the “standby” state 130 may be operatively coupled to a “calibrating” state 150. The “calibrating” state 150 may be a single state or a group of a plurality of states. In the “calibrating” state 150, a position and/or orientation of the at least one actuator and/or the at least one sensor of the 3D printing system may be determined and/or adjusted. Thus, in the “calibrating” state 150, a position and/or orientation of the one or more parts of the 3D printing system may be determined and/or adjusted. The state machine may be configured to transition from the “calibrating” state 150 to the “printing layer” state 160, once one or more calibration processes (e.g., all of the calibration processes) of the “calibrating state” 150 are completed. The “printing layer” state 160 be a single state or group of a plurality of states. The “printing layer” state 160 may comprise one or more commands to instruct the 3D printing system to print the at least the portion of the 3D object. Once the 3D printing process is complete (e.g., based on a computer model of the at least the portion of the 3D object), the “printing layer” state 160 may be configured to transition back to the “standby” state 130. In some cases, the “printing layer” state 160 may be operatively connected to an “intervention pause” state 170. The “intervention pause” state 170 may be a single state or group of a plurality of states. Upon completion of the necessary intervention (e.g., automatically by the 3D printing system and/or manually by the user), the “intervention pause” state 170 may be configured to transition back to the “printing layer” state 160 (e.g., a previously visited state, or a new state within the “printing layer” state 160, etc.) to re-start building the at least the portion of the 3D object. In some cases, any of the state of the state machine 100 can be configured to transition to an “emergency stopped” state 115. In an example, when the 3D printing system detects any malfunctioning that may not allow the 3D printing system to return to a normal state within the state machine, the state machine may transition to the “emergency stopped” state 115, and await for a user to intervene (e.g., reset the 3D printing system or the application back to the “initializing” state 120 of the state machine.

FIG. 1B schematically illustrates a plurality of states within the “calibrating” state 150 of the state machine 100. The “calibrating” state 150 may comprise a “raise coater wiper 1” state 151. The coater wiper 1 may be a first coater wiper of a deposition head configured to deposit a layer of a mixture for printing at least a portion of the 3D object. The state machine may be programmed to transition from the “standby” state 130 to the “raise coater wiper 1” state 151. The “raise coater wiper 1” state 151 may be programmed to transition (e.g., sequentially transition) to a plurality of other states within the “calibrating” state 150, including: a “raise coater drip tray 1” state, a “coater carriage to rest 1” state, a “Z axis to upper rest 1” state, a “raise the fluorinated ethylene propylene (FEP) 1” state, an “extend glass protective cover 1” state, a “move film transfer unit (FTU) to coating position 1” state, a “home three precision z positioners” state, a “FTU moved to coating area 1” state, a “move to Z calibration” state, a “Z1 calibration” state, a “Z2 calibration” state, a “Z3 calibration” state, a “Z4 calibration” state, a “Z5 calibration” state, a “Z6 calibration” state, a “Z7 calibration” state and/or a “Z8 calibration” state. The state machine may be configured to transition from a last state 159 of the “calibrating” state 150 (e.g., the “Z8 calibration” state) to the “printing layer” state 160. The FEP may be a film configured to hold at least a portion of the mixture. The FEP may be operatively coupled to (e.g., connected to) the FTU, and the FEP or at least a portion thereof may be independently actuatable relative to the FTU (e.g., vertically and/or laterally actuatable relative to the FTU).

FIG. 1C schematically illustrates a plurality of states within the “printing layer” state 160 and the “intervention pause” state 170. An initial state of the “printing layer” state 160 may be a “FTU moved to coating area” state 161. In an example, the last state 159 of the “calibrating” state 150 may be configured to transition into the “FTU moved to coating area” state 161. The “FTU moved to coating area” state 161 may be programmed to transition (e.g., sequentially transition) to a plurality of other states within the “printing layer” state 160, including: a “FTU down for wiping” state, a “dispensing” state (e.g., for dispensing the mixture from the deposition head), a “1 prep to wipe” state, a “2 prep to wipe” state, a “wiping” state 132 (e.g., wiping the window or the FEP for cleaning or flattening a deposited layer of the mixture), a “prep to recoat” state, a “recoating” state (e.g., recoating the deposited layer of the mixture), a “1 prepare for FTU lift” state, a “2 prepare for FTU lift” state, a “FTU lift” state, a “FTU moves to exposure” state, a “glass cover retracted” state, a “FTU ready to print” state, a “1 Z stage approach” state, a “2 Z stage approach” state, a “1 Z stage separation” state, a “2 Z stage separation” state, a “pre exposure” state, a “exposure” state (e.g., exposure of a deposited film of the mixture to a photoinitiation light and/or a photoinhibition light from at least one optical source), a “FTU lifted” state, and/or a “cover extended” state. After going through the plurality of states for one or more cycles, the “printing layer” state 160 may return to the “FTU moved to coating area” state 161. In some cases, when printing the desired 3D object is completed, the “printing layer” state 160 may be configured to transition from the “wiping” state 162 to the “standby” state 130.

Referring to FIG. 1C, in some cases, an intervention pause may be requested when the “printing layer” state 160 is at the “FTU moved to coating area” state 161. In such a case, the “FTU moved to coating area” state 161 may be configured to transition to the “intervention pause” state 170. The transition from the “printing layer” state 160 to the “intervention pause” state 170 may be programmed (e.g., after printing a predetermined number of layers of the 3D object, after consuming a predetermined amount of the mixture for printing, upon detecting an error by at least one sensor during the printing process, etc.) within the state machine. Alternatively or in addition to, the from the “printing layer” state 160 to the “intervention pause” state 170 may be instructed by the user (e.g., via a computer operatively coupled to the 3D printing system, via a separate user device operatively coupled to the 3D printing system, etc.). A first state of the “intervention pause” state 170 may be the “pause intervention standby” state 171. The “pause intervention standby” state 171 may be configured to transition (e.g., sequentially transition) to a plurality of other states within the “intervention pause” state 170, including: a “raise coater wiper” state, a “raise coater drip tray” state, a “coater carriage to rest” state, a “Z axis to upper rest” state, a “raise the FEP” state, a “extend glass protective cover” state, a “move FTU to coating area” state, and/or a “FTU moved to coating area” state 172. In some cases, the “FTU moved to coating area” state 172 may be the final state of the “intervention pause” state 170, after which the state machine may be configured to transition back to the “printing layer” state 160 (e.g., the “FTU moved to coating area” state 161).

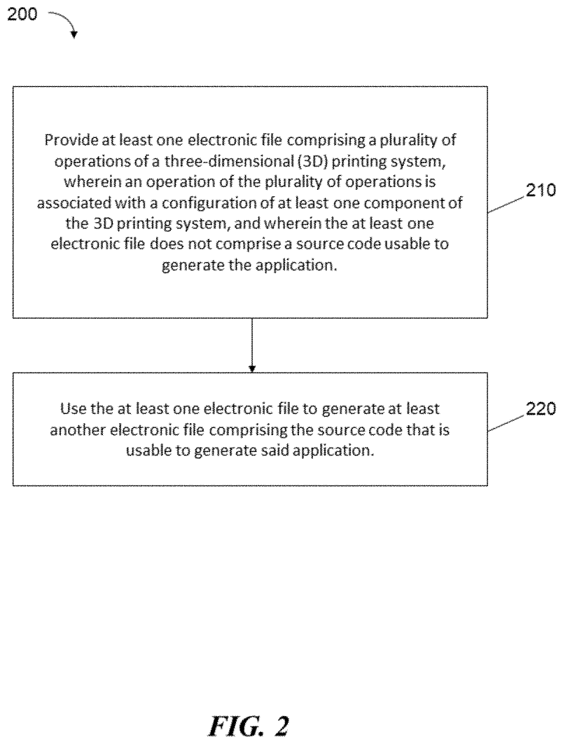

FIG. 2 illustrates an example flowchart 200 of a computer-implemented method for generating an application executable by a 3D printing system to print a 3D object. The method may comprise providing at least one electronic file (e.g., a .CSV file) comprising a plurality of operations of a 3D printing system (process 210). An operation of the plurality of operations may be associated with a configuration of at least one component of the 3D printing system. The at least one electronic file may not comprise a source code usable to generate the application. The method may further comprise using the at least one electronic file to generate at least another electronic file (e.g., using a C++ code generator to generate a .H heater and a .CPP source code) comprising the source code that is usable to generate said application (process 220).

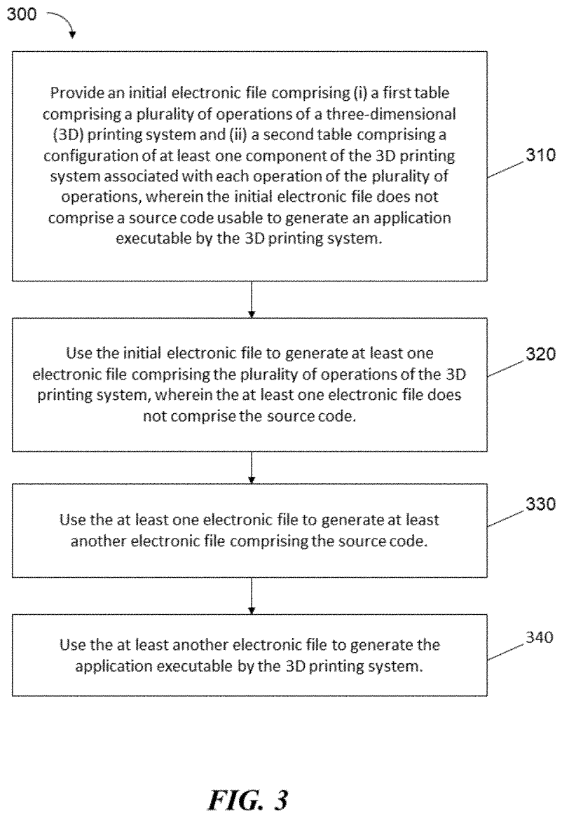

FIG. 3 illustrates another example flowchart 300 of a computer-implemented method for generating an application executable by a 3D printing system to print a 3D object. The method may comprise providing an initial electronic file (e.g., a .XLS file) comprising (i) a first table (e.g., a first spreadsheet tab) comprising a plurality of operations (e.g., a state machine) of a 3D printing system and (ii) a second table (e.g., a second spreadsheet tab) comprising a configuration of at least one component of the 3D printing system associated with each operation of the plurality of operations (process 310). For example, the second table may comprise (1) a first spreadsheet that comprises a configuration of a plurality of actuators for each operation of the plurality of operations of the 3D printing system and (2) a second spreadsheet that comprises a configuration of a plurality of sensors for each operation of the plurality of operations of the 3D printing system. In some cases, the initial electronic file may further comprise another table comprising a library of the plurality of operations. The initial electronic file may not comprise a source code usable to generate an application executable by the 3D printing system. The method may further comprise using the initial electronic file to generate at least one electronic file (e.g., a .CSV file) comprising the plurality of operations of the 3D printing system (process 320). The at least one electronic file may not comprise the source code. For example, a macro operator in Microsoft® Office Excel may convert the initial .XLS file into three electronic files: (1) a first .CSV file comprising the plurality of operations (e.g., a state machine) of the 3D printing system, (2) a second .CSV file comprising the configuration of the plurality of actuators for each operation of the plurality of operations of the 3D printing system, and (3) a third .CSV file comprising the configuration of the plurality of sensors for each operation of the plurality of operations of the 3D printing system. The method may further comprise using the at least one electronic file to generate at least another electronic file comprising the source code (process 330). For example, a C++ code generator may be used to automatically convert the first .CSV file comprising the state machine into a .H heater and a .CPP source code. The method may further comprise using the at least another electronic file to generate the application executable by the 3D printing system (process 340). For example, the .H heater and the .CPP source code may be compiled into an object file (e.g., a .OBJ file). The object file may be converted into an application (e.g., a .EXE file application) that is executable by a 3D printing system or a computer operatively coupled to the 3D printing system. In some cases, the application may be configured to read the second and third .CSV files during 3D printing for controlling the actuators and sensors at each state of the state machine. In some cases, the application may be configured to receive a computer model (e.g., a computer-aided design (CAD) file, such as .DWG, .DXF, .DGN, and .STL file) of the 3D object for printing such 3D object.

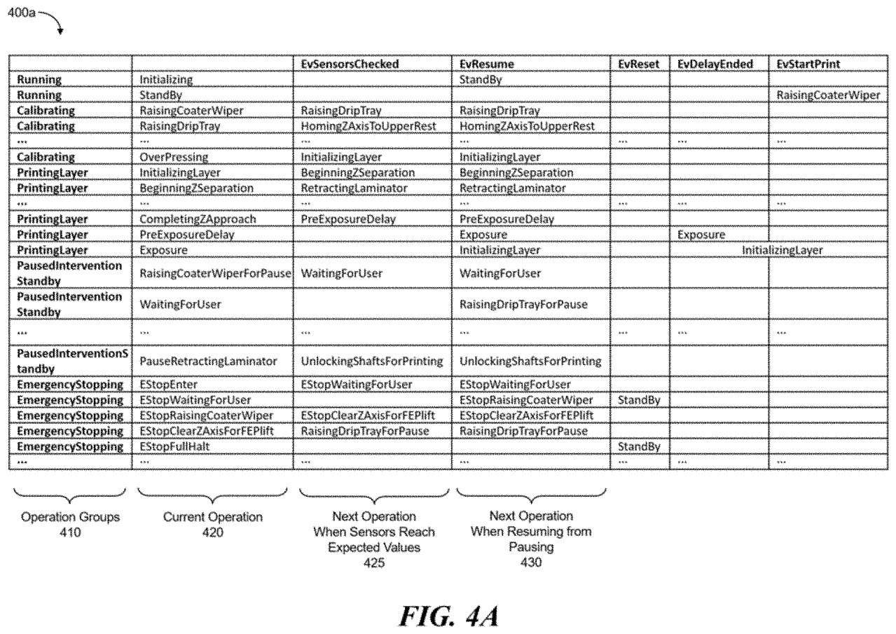

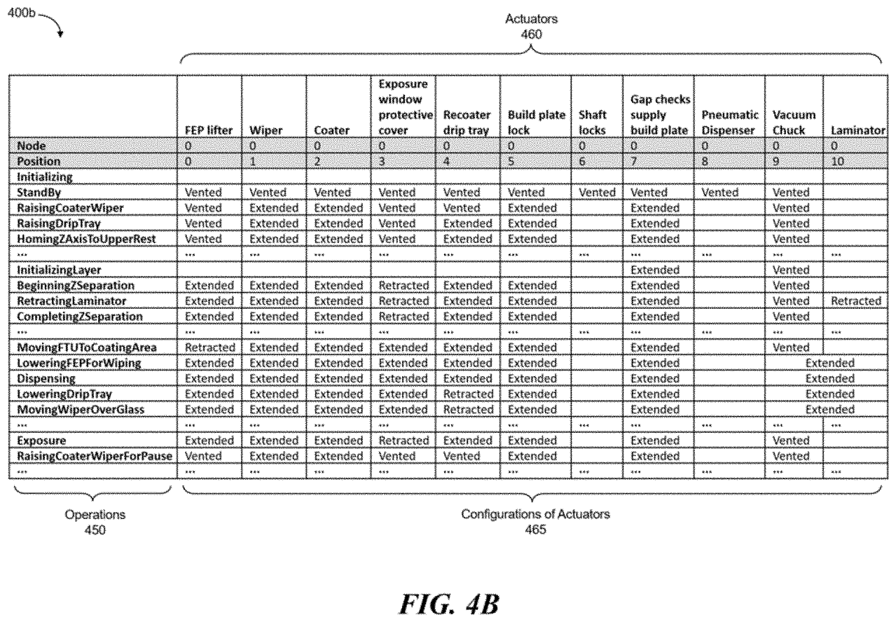

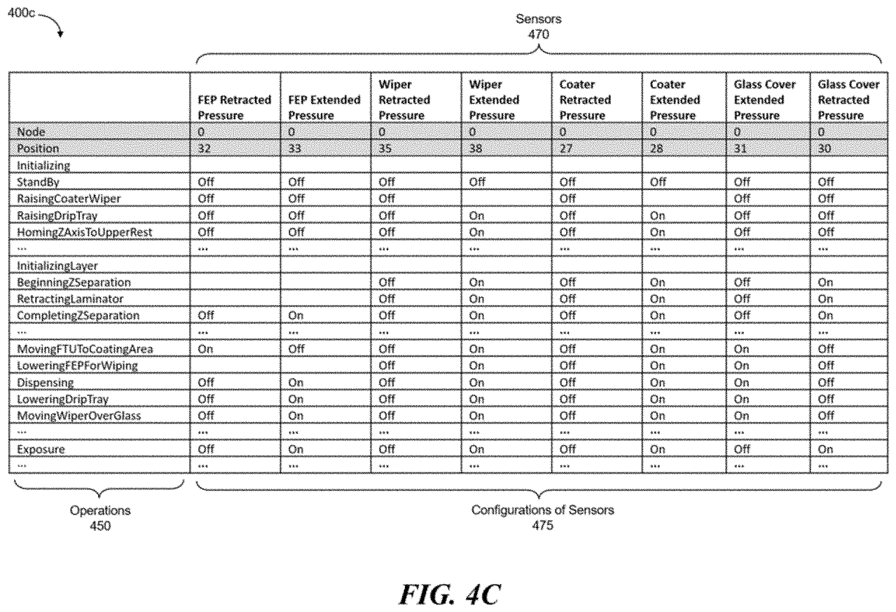

FIG. 4A shows an example table 400a comprising the plurality of operations (e.g., a state machine) of the 3D printing system. The table 400a may be provided as a spreadsheet in the initial electronic file (e.g., a .XLS file). Alternatively, the table 400a may be provided in an electronic file (e.g., a .CSV file). The table 400a may not comprise any source code. The table 400a may comprise a column that lists a current operation 420 that the 3D printing system is in. The current operation may be selected from the plurality of operations (e.g., all of the operations provided in FIGS. 1A-1C). The operations may be grouped into a collection of operations (or a collection of states) 410. For each of the current operation 420, the table 400a may further provide a subsequent operation of the 3D printing system depending on one or more scenarios. For example, the table 400a may provide a subsequent operation 435 when sensor data obtained by one or more sensors of the 3D printing system are within predetermined values. In another example, the table 400a may provide a subsequent operation 430 when the 3D printing system has been paused at the current operation.

FIG. 4B shows an example table 400b comprising a configuration of a plurality of actuators for each operation of the plurality of operations of the 3D printing system. The table 400b may be provided as a spreadsheet in the initial electronic file (e.g., a .XLS file). Alternatively, the table 400b may be provided in an electronic file (e.g., a .CSV file). The table 400b may not comprise any source code. The table 400b may comprise a row of the plurality of actuators 460. The table 400b may further comprise a row indicating a relative identification (or positioning, such as 1 through 10) of each of the plurality of actuators 460 within the 3D printing system. The table 400b may further comprise a column indicating the plurality of operations 450 of the 3D printing system. The table 400b may further comprise a configuration 465 of each actuator (e.g., vented, extended, retracted, or “. . . ” for unchanged) for each of the operation of the plurality of operations 450.

FIG. 4C shows an example table 400c comprising a configuration of a plurality of sensors for each operation of the plurality of operations of the 3D printing system. The table 400c may be provided as a spreadsheet in the initial electronic file (e.g., a .XLS file). Alternatively, the table 400c may be provided in an electronic file (e.g., a .CSV file). The table 400c may not comprise any source code. The table 400c may comprise a row of the plurality of actuators 470. The table 400c may further comprise a row indicating a relative identification (or positioning) of each of the plurality of sensors 470 within the 3D printing system. The table 400c may further comprise a column indicating the plurality of operations 450 of the 3D printing system. The table 400c may further comprise a configuration 475 of each sensor (e.g., on, off, or “. . . ” for unchanged) for each of the operation of the plurality of operations 450.

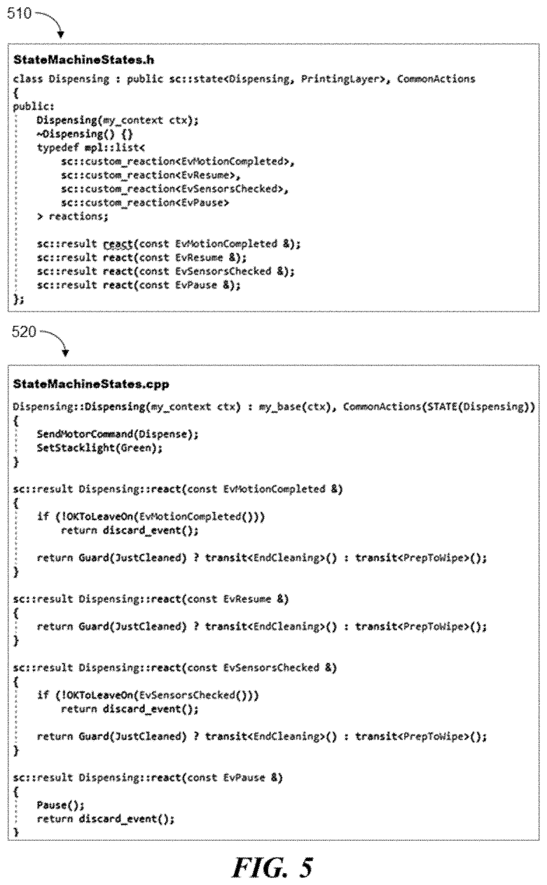

FIG. 5 shows examples of the at least another electronic file 500 comprising the source code that is usable to generate the application that is executable for the 3D printing system. A C++ code generator may be used to convert a spreadsheet of a plurality of operations of the 3D printing system (e.g., the table 400a as shown in FIG. 4A) into the at least another electronic file comprising the source code. For example, the C++ code generator may generate a .H header file 510 and a .CPP source code file 520.

Systems for 3D Printing

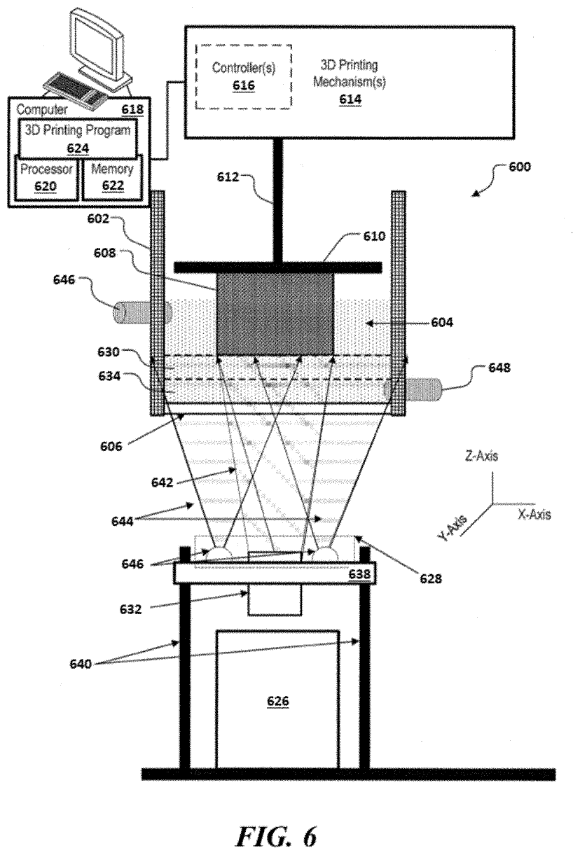

FIG. 6 shows an example of a 3D printing system 600. The system 600 includes a vat 602 to hold a mixture 604, which includes a polymeric precursor. The vat 602 includes a window 606 in its bottom through which illumination is transmitted to cure a 3D printed structure 608. The 3D printed structure 608 is shown in FIG. 6 as a block, however, in practice a wide variety of complicated shapes can be 3D printed. In some cases, the 3D printed structure 608 includes entirely solid structures, hollow core prints, lattice core prints and generative design geometries. Additionally, a 3D printed structure 608 can be partially cured such that the 3D printed structure 608 has a gel-like or viscous mixture characteristic.

The 3D printed structure 608 is 3D printed on a build head 610, which is connected by a rod 612 to one or more 3D printing mechanisms 614. The 3D printing mechanisms 614 can include various mechanical structures for moving the build head 610 within and above the vat 602. This movement is a relative movement, and thus moving pieces can be the build head 610, the vat 602, or both, in various cases. In some cases, the 3D printing mechanisms 614 include Cartesian (xyz) type 3D printer motion systems or delta type 3D printer motion systems. In some cases, the 3D printing mechanisms 614 include one or more controllers 616 which can be implemented using integrated circuit technology, such as an integrated circuit board with embedded processors and firmware. Such controllers 616 can be in communication with a computer or computer systems 618. In some cases, the 3D printing system 600 includes a computer 618 that connects to the 3D printing mechanisms 614 and operates as a controller for the 3D printing system 600.

A computer 618 can include one or more hardware (or computer) processors 620 and a memory 622. For example, a 3D printing program 624 can be stored in the memory 622 and run on the one or more processors 620 to implement the techniques described herein. The controller 618, including the one or more hardware processors 620, may be individually or collectively programmed to implement methods of the present disclosure.

Multiple devices emitting various wavelengths and/or intensities of light, including a light projection device 626 and light sources 628, can be positioned below the window 606 and in communication to the computer 618 (or other controller). In some cases, the multiple devices include the light projection device 626 and the light sources 628. The light sources 628 can include greater than or equal to about 2, 3, 4, 5, 6, 7, 8, 9, 10, or more light sources. As an alternative, the light sources 628 may include less than or equal to about 10, 9, 8 7, 6, 5, 4, 3, 2 or less light sources. As an alternative to the light sources 628, a single light source may be used. The light projection device 626 directs a first light having a first wavelength into the mixture 604 within the vat 602 through window 606. The first wavelength emitted by the light projection device 626 is selected to produce photoinitiation and is used to create the 3D printed structure 608 on the build head 610 by curing the photoactive resin in the mixture 604 within a photoinitiation layer 60630. In some cases, the light projection device 626 is utilized in combination with one or more projection optics 62632 (e.g. a projection lens for a digital light processing (DLP) device), such that the light output from the light projection device 626 passes through one or more projection optics 62632 prior to illuminating the mixture 604 within the vat 602.

In some cases, the light projection device 626 is a DLP device including a digital micro-mirror device (DMD) for producing patterned light that can selectively illuminate and cure 3D printed structures 608. The light projection device 626, in communication with the computer 618, can receive instructions from the 3D printing program 624 defining a pattern of illumination to be projected from the light projection device 626 into the photoinitiation layer 60630 to cure a layer of the photoactive resin onto the 3D printed structure 608.

In some cases, the light projection device 626 and projection optics 632 are a laser and a scanning mirror system, respectively (e.g., stereolithography apparatus). Additionally, in some cases, the light source includes a second laser and a second scanning mirror system. Such light source may emit a beam of a second light having a second wavelength. The second wavelength may be different from the first wavelength. This may permit photoinhibition to be separately controlled from photoinitiation. Additionally, in some cases, the platform 638 is separately supported on adjustable axis rails 640 from the projection optics 632 such that the platform 638 and the projection optics 632 can be moved independently.

The relative position (e.g., vertical position) of the platform 638 and the vat 602 may be adjusted. In some examples, the platform 638 is moved and the vat 602 is kept stationary. As an alternative, the platform 638 is kept stationary and the vat 602 is moved. As another alternative, both the platform 638 and the vat 602 are moved.

The light sources 628 direct a second light having a second wavelength into the mixture 604 in the vat 602. The second light may be provided as multiple beams from the light sources 628 into the build area simultaneously. As an alternative, the second light may be generated from the light sources 628 and provided as a single beam (e.g., uniform beam) into the beam area. The second wavelength emitted by the light sources 628 is selected to produce photoinhibition in the photoactive resin in the mixture 604 and is used to create a photoinhibition layer 634 within the mixture 604 directly adjacent to the window 606. The light sources 628 can produce a flood light to create the photoinhibition layer 634, the flood light being a non-patterned, high-intensity light.

In some cases, the light sources 628 are light emitting diodes (LEDs) 336. The light sources 628 can be arranged on a platform 638. The platform 638 is mounted on adjustable axis rails 640. The adjustable axis rails 640 allow for movement of the platform 638 along an axis. In some cases, the platform 638 additionally acts as a heat-sink for at least the light sources 628 arranged on the platform 638.

The respective thicknesses of the photoinitiation layer 630 and the photoinhibition layer 634 can be adjusted by computer 618 (or other controller). In some cases, this change in layer thickness(es) is performed for each new 3D printed layer, depending on the desired thickness of the 3D printed layer, and/or the type of 3D printing process being performed. The thickness(es) of the photoinitiation layer 630 and the photoinhibition layer 634 can be changed, for example, by changing the intensity of the respective light emitting devices, exposure times for the respective light emitting devices, the photoactive species in the mixture 604, or a combination thereof. In some cases, by controlling relative rates of reactions between the photoactive species (e.g., by changing relative or absolute amounts of photoactive species in the mixture, or by adjusting light intensities of the first and/or second wavelength), the overall rate of polymerization can be controlled. This process can thus be used to prevent polymerization from occurring at the resin-window interface and control the rate at which polymerization takes place in the direction normal to the resin-window interface.

For example, in some cases, an intensity of the light sources 628 emitting a photoinhibiting wavelength to create a photoinhibition layer 634 is altered in order to change a thickness of the photoinhibition layer 634. Altering the intensity of the light sources 628 can include increasing the intensity or decreasing the intensity of the light sources 628. Increasing the intensity of the light sources 628 (e.g., LEDs) can be achieved by increasing a power input to the light sources 628 by controllers 616 and/or computer 618. Decreasing the intensity of the light sources 628 (e.g., LEDs) can be achieved by decreasing a power input to the light sources 628 by controllers 616 and/or computer 618. In some cases, increasing the intensity of the light sources 628, and thereby increasing the thickness of the photoinhibition layer 634, will result in a decrease in thickness of the photoinitiation layer 630. A decreased photoinitiation layer thickness can result in a thinner 3D printed layer on the 3D printed structure 608.

In some cases, the intensities of all of the light sources 628 are altered equally (e.g., decreased by a same level by reducing power input to all the light sources by an equal amount). The intensities of the light sources 628 can also be altered where each light source of a set of light sources 628 produces a different intensity. For example, for a set of four LEDs generating a photoinhibition layer 634, two of the four LEDs can be decreased in intensity by 10% (by reducing power input to the LEDs) while the other two of the four LEDs can be increased in intensity by 10% (by increasing power input to the LEDs). Setting different intensities for a set of light sources 628 can produce a gradient of thickness in a cured layer of the 3D printed structure or other desirable effects.

In some cases, the computer 618 (in combination with controllers 616) adjusts an amount of a photoinitiator species and/or a photoinhibitor species in the mixture 604. The photoinitiator and photoinhibitor species can be delivered to the vat 602 via an inlet 646 and evacuated from the vat 602 via an outlet 648. In general, one aspect of the photoinhibitor species is to prevent curing (e.g., suppress cross-linking of the polymers) of the photoactive resin in the mixture 604. In general, one aspect of the photoinitiation species is to promote curing (e.g., enhance cross-linking of the polymers) of the photoactive resin in the mixture 604. In some cases, the 3D printing system 600 includes multiple containment units to hold input/output flow from the vat 602.

In some cases, the intensities of the light sources 628 are altered based in part on an amount (e.g., volumetric or weight fraction) of the one or more photoinhibitor species in the mixture and/or an amount (e.g., volumetric or weight fraction) of the one or more photoinitiator species in the mixture. Additionally, the intensities of the light sources 628 are altered based in part on a type (e.g., a particular reactive chemistry, brand, composition) of the one or more photoinhibitor species in the mixture and/or a type (e.g., a particular reactive chemistry, brand, composition) of the one or more photoinitiator species in the mixture. For example, an intensity of the light sources 628 for a mixture 604 including a first photoinhibitor species of a high sensitivity (e.g., a high reactivity or conversion ratio to a wavelength of the light sources 628) can be reduced when compared to the intensity of the light sources 628 for a mixture 604 including a second photoinhibitor species of a low sensitivity (e.g., a low reactivity or conversion ratio to a wavelength of the light sources 628).

In some cases, the changes to layer thickness(es) is performed during the creation of the 3D printed structure 608 based on one or more details of the 3D printed structure 608 at one or more points in the 3D printing process. For example, the respective layer thickness(es) can be adjusted to improve resolution of the 3D printed structure 608 in the dimension that is the direction of the movement of the build head 610 relative to the vat 602 (e.g., z-axis) in the layers that require it.

Though the 3D printing system 600 is described in FIG. 6 as a bottom-up system where the light projection device 626 and the light sources 628 are located below the vat 602 and build head 610, other configurations can be utilized. For example, a top-down system, where the light projection device 626 and the light sources 628 are located above the vat 602 and build head 610, can also be employed.

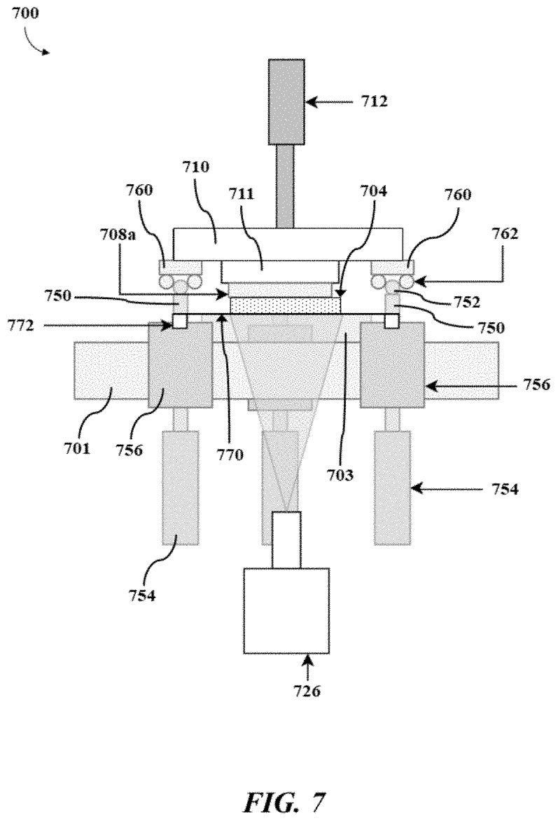

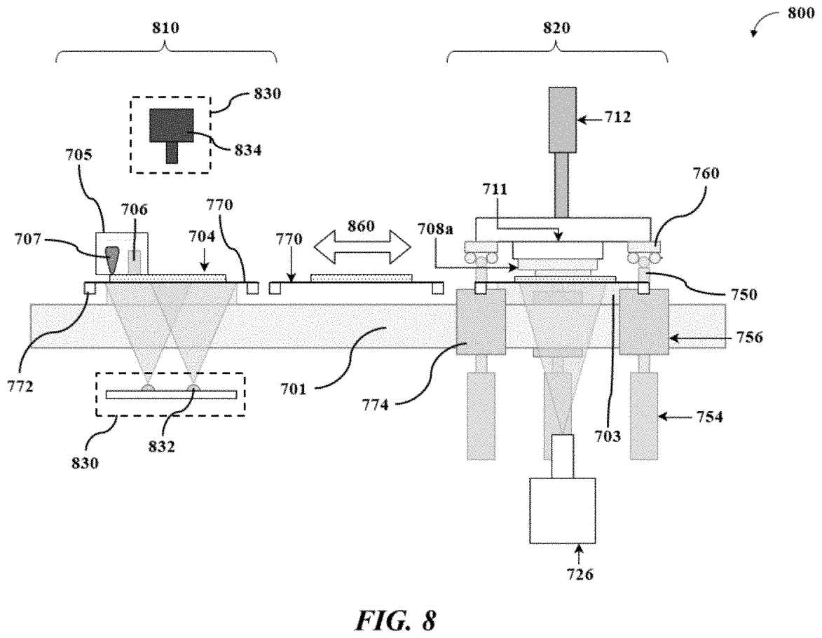

FIGS. 7 and 8 show additional examples of a 3D printing system. Referring to FIG. 7, the system 700 includes a platform 701 comprising an area (i.e., a print surface, such as a film 770) configured to hold the mixture 704 or a film of the mixture 704, which includes a photoactive resin. The mixture 704 may include a plurality of particles (e.g., metal, intermetallic, and/or ceramic particles). The platform 701 comprises a print window 703. The system 700 further comprises a film transfer unit 772 that is configured to hold the film 770. The film transfer unit is operatively coupled to one or more actuators to dispose the film 770 onto the print window 703.

The platform 701 comprises a plurality of first coupling units 750. The platform 701 is an open platform, wherein the mixture 704 is self-supporting on or adjacent to the film 770 without requiring support or being supported by any wall. The plurality of first coupling units 750 are not in contact with the mixture 704 during 3D printing. The system 700 includes a build head 710 configured to move relative to the platform 701. The build head 710 is movable by an actuator 712 (e.g., a linear actuator) operatively coupled to the build head 710. Alternatively or in addition to, the platform 701 may comprise one or more actuators to move the platform 701 relative to the build head 710. The build head 710 comprises a surface 711 configured to hold at least a portion of a 3D object 708a (e.g., a previously printed portion of the 3D object) or a different object onto which the at least the portion of the 3D object is to be printed. The surface 711 of the build head 710 may be a portion of a surface of the build head 710. Alternatively or in addition to, the surface 711 may be a surface of an object (e.g., a film or a slab) that is disposed on or adjacent to a surface of the build head 710. The build head 710 comprises a plurality of second coupling units 760. One of the plurality of second coupling units 760 of the build head 710 is configured to couple to one of the plurality of the first coupling units 750 of the platform 701 to provide an alignment of film 770 relative to the surface 711 of the build head 710 during 3D printing. In some examples, the plurality of first coupling units 750 (e.g., three first coupling units) and the plurality of second coupling units 760 (e.g., three second coupling units) may couple to generate a kinematic coupling between the build head 710 and the film 770, to provide an alignment between the build head 710 and the film 770. The relative movement between the build head and the platform may continue until each of the plurality of first coupling units 750 is coupled to its respective second coupling unit from the plurality of second coupling units 760 (or vice versa).

One or more of the plurality of first coupling units 750 of the platform 701 may comprise one or more sensors 752. Alternatively or in addition to, one or more of the plurality of second coupling units 760 of the build head 710 may comprise one or more sensors 762. The one or more sensors 752 and/or the one or more sensors 762 may be configured to at least detect coupling of the first coupling unit(s) 750 and the second coupling unit(s) 760.

The plurality of first coupling units 750 of the platform 701 may be operatively coupled to one or more actuators 754 (e.g., one or more z-axis telescopic actuators) configured to adjust a height (or protrusion) of the plurality of first coupling units 750 relative to the platform 701 (or relative to a surface of the film 770 disposed adjacent to the platform 701). The one or more actuators 754 may comprise one or more fasteners 756 (e.g., one or more shaft clamps) configured to fasten, hold on to, or stabilize a movement of the plurality of first coupling units 750 relative to the actuators 754.

The plurality of second coupling units 760 of the build head 710 may be operatively coupled to one or more actuators (e.g., one or more z-axis telescopic actuators) configured to adjust a height (or protrusion) of the plurality of second coupling units 760 relative to a surface 711 of the build head 710 (or relative to a surface of the object 708a disposed on the build head 710). The one or more actuators may comprise one or more fasteners (e.g., one or more shaft clamps) configured to fasten, hold on to, or stabilize a movement of the plurality of second coupling units 760 relative to the actuators.

One or more optical sources 726 directs one or more lights to the mixture 704 to cure the photoactive resin in the at least the portion of the mixture 704, thereby to print at least a portion of the 3D object on the surface of the build head 710 or a surface of the object 708a disposed on the surface of the build head 710. The optical source(s) 726 may direct the light(s) through the print surface 702 of the platform 701 and to the at least the portion of the mixture for 3D printing.

Referring to FIG. 8, the 3D printing system 800 comprises a mixture deposition zone 810 and a printing zone 820 that are (i) connected to a same platform 701 or (ii) coupled to the same platform 701. The system 800 further comprises a deposition head 705 configured to deposit a mixture 704 to the platform 701, print window 703, and/or film 770 configured to hold a mixture. In this example, the deposition head is configured to deposit the mixture 704 onto the film 770. The deposition head 705 comprises a nozzle 707 that is in fluid communication with a source of the mixture 704 and at least one wiper 706 configured to (i) reduce or inhibit flow the mixture 704 out of the deposition head 705, (ii) flatten the mixture 704 into a film or layer of the mixture 704, and/or (iii) remove any excess of the 704 from the film 770. The system 800 further comprises a mixture sensor 830 (e.g., a camera, a densitometer, etc.) configured to detect one or more qualities of the mixture 704 that is deposited onto the film 770. The mixture sensor comprises a mixture sensor light source 832 and a mixture sensor detector 834. The mixture sensor light source 832 is disposed beneath the film 770, and the mixture sensor detector 834 is disposed above the film 770. Alternatively or in addition to, the mixture sensor light source 832 and the mixture sensor detector 834 may be disposed inversely or on the same side of the film 770. Subsequent to depositing a layer of the mixture 704 on the film 770, the mixture sensor light source 832 may emit a sensor light (e.g., infrared light) through at least the film 770 and towards the layer of mixture 704 on or adjacent to the film 770, and the mixture sensor detector 834 may capture or detect any of the infrared light that is transmitted through the layer of the mixture 704. Measurements by the mixture sensor 830 can help determine whether a quality of the layer of the mixture 704 is sufficient to proceed with printing at least a portion of the 3D object. The printing zone 820 can comprise one or more components of the 3D printing system 700 provided in FIG. 7.

Referring to FIG. 8, the film 770 is coupled to a film transfer unit 772. The film transfer unit 772 is configured to move 860 at least between and/or over the mixture deposition zone 810 and the printing zone 820.

Other features any of the 3D printing systems and methods may be as described in, for example, U.S. Patent Publication No. 2016/0067921 (“THREE DIMENSIONAL PRINTING ADHESION REDUCTION USING PHOTOINHIBITION”), U.S. Patent Publication No. 2018/0348646 (“MULTI WAVELENGTH STEREOLITHOGRAPHY HARDWARE CONFIGURATIONS”), U.S. Patent Publication No. 2018/0333911 (“VISCOUS FILM THREE-DIMENSIONAL PRINTING SYSTEMS AND METHODS”), International Application No. PCT/US2019/068413 (“SENSORS FOR THREE-DIMENSIONAL PRINTING SYSTEMS AND METHODS”), and U.S. Provisional Application No. 62/849,596 (“STEREOLITHOGRAPHY THREE-DIMENSIONAL PRINTING SYSTEMS AND METHODS”), each of which is entirely incorporated herein by reference.

Computer Systems

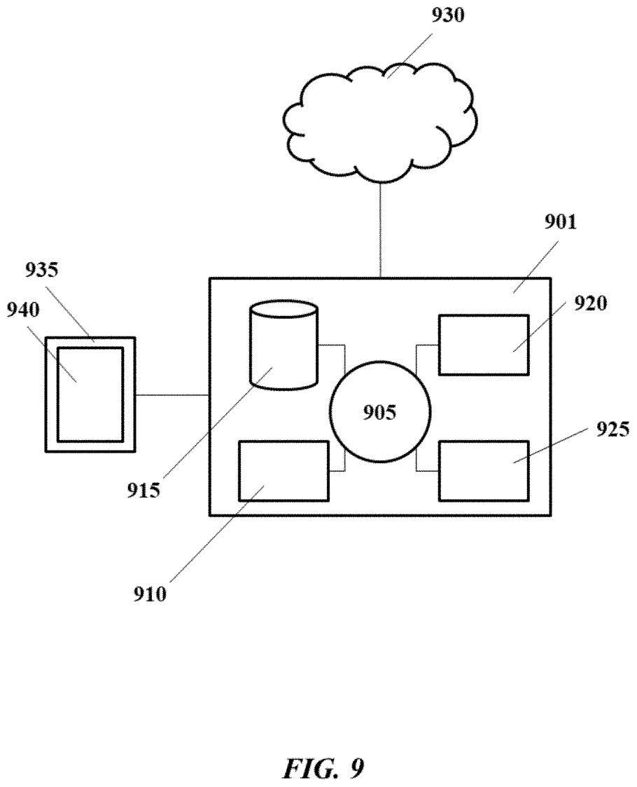

The present disclosure provides computer systems that are programmed to implement methods of the disclosure. FIG. 9 shows a computer system 901 that is programmed or otherwise configured to, for example, generate an application executable by a system (e.g., a 3D printing system) according to any of the methods provided herein. The computer system 901 can regulate various aspects of generating such application and/or various aspects of the 3D printing process of the present disclosure. In some cases, the computer system 901 can be an electronic device of a user or a computer system that is remotely located with respect to the electronic device. The electronic device can be a mobile electronic device.

The computer system 901 includes a central processing unit (CPU, also “processor” and “computer processor” herein) 905, which can be a single core or multi core processor, or a plurality of processors for parallel processing. The computer system 901 also includes memory or memory location 910 (e.g., random-access memory, read-only memory, flash memory), electronic storage unit 915 (e.g., hard disk), communication interface 920 (e.g., network adapter) for communicating with one or more other systems, and peripheral devices 925, such as cache, other memory, data storage and/or electronic display adapters. The memory 910, storage unit 915, interface 920 and peripheral devices 925 are in communication with the CPU 905 through a communication bus (solid lines), such as a motherboard. The storage unit 915 can be a data storage unit (or data repository) for storing data. The computer system 901 can be operatively coupled to a computer network (“network”) 930 with the aid of the communication interface 920. The network 930 can be the Internet, an internet and/or extranet, or an intranet and/or extranet that is in communication with the Internet. The network 930 in some cases is a telecommunication and/or data network. The network 930 can include one or more computer servers, which can enable distributed computing, such as cloud computing. The network 930, in some cases with the aid of the computer system 901, can implement a peer-to-peer network, which may enable devices coupled to the computer system 901 to behave as a client or a server.

The CPU 905 can execute a sequence of machine-readable instructions, which can be embodied in a program or software. The instructions may be stored in a memory location, such as the memory 910. The instructions can be directed to the CPU 905, which can subsequently program or otherwise configure the CPU 905 to implement methods of the present disclosure. Examples of operations performed by the CPU 905 can include fetch, decode, execute, and writeback.

The CPU 905 can be part of a circuit, such as an integrated circuit. One or more other components of the system 901 can be included in the circuit. In some cases, the circuit is an application specific integrated circuit (ASIC).

The storage unit 915 can store files, such as drivers, libraries and saved programs. The storage unit 915 can store user data, e.g., user preferences and user programs. The computer system 901 in some cases can include one or more additional data storage units that are external to the computer system 901, such as located on a remote server that is in communication with the computer system 901 through an intranet or the Internet.

The computer system 901 can communicate with one or more remote computer systems through the network 930. For instance, the computer system 901 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 901 via the network 930.

Methods as described herein can be implemented by way of machine (e.g., computer processor) executable code stored on an electronic storage location of the computer system 901, such as, for example, on the memory 910 or electronic storage unit 915. The machine executable or machine readable code can be provided in the form of software. During use, the code can be executed by the processor 905. In some cases, the code can be retrieved from the storage unit 915 and stored on the memory 910 for ready access by the processor 905. In some situations, the electronic storage unit 915 can be precluded, and machine-executable instructions are stored on memory 910.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 901, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 901 can include or be in communication with an electronic display 935 that comprises a user interface (UI) 940 for providing, for example, (i) access to one or more electronic files (e.g., for selecting or modifying) to be used for generating the application executable by the 3D printing system, and/or (ii) access to the 3D printing system (e.g., for initiating and/or intervening the 3D printing process. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 905. The algorithm can, for example, operate the 3D printing machine based on the state machine described in the application.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A computer-implemented method for generating an application executable by a three-dimensional (3D) printing system to print a 3D object, comprising:
(a) providing at least one electronic file comprising a plurality of operations of said 3D printing system, wherein an operation of said plurality of operations is associated with a configuration of at least one component of said 3D printing system, and wherein said at least one electronic file does not comprise a source code usable to generate said application; and
(b) using said at least one electronic file to generate at least another electronic file comprising said source code that is usable to generate said application.

2. The computer-implemented method of claim 1, wherein said at least one component comprises (i) at least one actuator configured to control movement of at least one part of said 3D printing system or (ii) at least one sensor configured to detect movement or condition of said at least one part of said 3D printing system.

3. The computer-implemented method of claim 2, wherein said at least one component comprises (i) said at least one actuator and (ii) said at least one sensor.

4. The computer-implemented method of claim 2, wherein said at least one part comprises one or more members selected from the group consisting of: a build head, a platform, a deposition head, a wiper, a film transfer unit, a coupling unit, an optical source, a camera, and a mixture usable for printing said 3D object.

5. The computer-implemented method of claim 1, wherein said at least one electronic file comprises (i) a first electronic file comprising said plurality of operations of said 3D printing system and (ii) a second electronic file comprising said configuration of said at least one component of said 3D printing system associated with each operation of said plurality of operations.

6. The computer-implemented method of claim 5, wherein said second electric file comprises a plurality of electronic files for a plurality of components of said at least one component of said 3D printing system associated with each operation of said plurality of operations.

7. The computer-implemented method of claim 1, further comprising, in (a), using an initial electronic file to generate said at least one electronic file, wherein said initial electronic file comprises (i) a first table comprising said plurality of operations of said 3D printing system and (ii) a second table comprising said configuration of said at least one component of said 3D printing system associated with each operation of said plurality of operations.

8. The computer-implemented method of claim 7, wherein said second table comprises a plurality of tables for a plurality of components of said 3D printing system associated with each operation of said plurality of operations.

9. The computer-implemented method of claim 7, wherein said generating said at least one electronic file is performed automatically by said computer.

10. The computer-implemented method of claim 1, wherein, in (b), said generating said at least another electronic file is performed automatically by said computer.

11. The computer-implemented method of claim 1, wherein said plurality of operations are grouped into different processes of said 3D printing system in said at least one electronic file.

12. The computer-implemented method of claim 1, wherein said application comprises an instruction for said 3D printing system to automatically transition from a first operation to a second operation of said plurality of operations.

13. The computer-implemented method of claim 1, further comprising using said at least another electronic file to generate said application executable by said 3D printing system.

14. The computer-implemented method of claim 1, wherein said 3D printing system comprises a state machine controller configured to execute said application to print said 3D object.

15. A system for generating an application executable by a three-dimensional (3D) printing system to print a 3D object, comprising:
a computer storage unit configured to store at least one electronic file comprising a plurality of operations of said 3D printing system, wherein an operation of said plurality of operations is associated with a configuration of at least one component of said 3D printing system, and wherein said at least one electronic file does not comprise a source code usable to generate said application; and
one or more computer processors operatively coupled to said computer storage unit, wherein said one or more computer processors are individually or collectively programmed to (i) retrieve said at least one electronic file from said computer storage unit, and (ii) use said at least one electronic file to generate at least another electronic file comprising said source code that is usable to generate said application.

16. The system of claim 15, wherein said at least one component comprises (i) at least one actuator configured to control movement of at least one part of said 3D printing system or (ii) at least one sensor configured to detect movement or condition of said at least one part of said 3D printing system.

17. The system of claim 15, wherein said at least one electronic file comprises (i) a first electronic file comprising said plurality of operations of said 3D printing system and (ii) a second electronic file comprising said configuration of said at least one component of said 3D printing system associated with each operation of said plurality of operations.

18. The system of claim 15, wherein said application comprises an instruction for said 3D printing system to automatically transition from a first operation to a second operation of said plurality of operations.

19. The system of claim 15, further comprising a state machine controller configured to execute said application to print said 3D object.

20. A computer-readable medium comprising non-transitory, machine-executable instructions that, upon execution by one or more computer processors, implements a method for generating an application executable by a three-dimensional (3D) printing system to print a 3D object, said method comprising:
(a) providing at least one electronic file comprising a plurality of operations of said 3D printing system, wherein an operation of said plurality of operations is associated with a configuration of at least one component of said 3D printing system, and wherein said at least one electronic file does not comprise a source code usable to generate said application; and
(b) using said at least one electronic file to generate at least another electronic file comprising said source code that is usable to generate said application.
